(19) United States
(12) Patent Application Publication
(10) Pub. No.: US 2013/0204797 A1
(43) Pub. Date: Aug. 8, 2013

(54) Job Estimate Development

(71) Applicants: Uwe Kleinschmidt, Santa Barbara, CA (US); Ute Gerlach, Stuttgart (DE); Svatjoslav Rilov, Lynnwood, WA (US)

(72) Inventors: Uwe Kleinschmidt, Santa Barbara, CA (US); Ute Gerlach, Stuttgart (DE); Svatjoslav Rilov, Lynnwood, WA (US)

(73) Assignee: AutoVitals, Inc., Santa Barbara, CA (US)

(21) Appl. No.: 13/368,951

(22) Filed: Feb. 8, 2012

(51) Int. Cl. G06Q 10/00

(52) U.S. Cl. 705/306

(57) ABSTRACT

A method for job estimate development includes receiving a custom image of a specific automobile, the image including a depiction of a subject of a proposed repair operation and obtaining estimate data for a proposed repair operation on the specific automobile, wherein the proposed repair corresponds to the image, the estimate data including parts costs and labor costs associated with the proposed repair operation. The method further includes obtaining a unit of educational content associated with the proposed repair operation, the unit of educational content pre-associated with the proposed repair operation and selected from a library of educational content, the unit of educational content including a visual depiction of the proposed repair operation and providing a repair cost estimate including the estimate data, the image and the unit of educational content to a customer for review prior to authorization of the proposed repair.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to job estimate development.

2. Description of the Related Art

In a typical job estimate scenario, a customer, such as an automobile owner, drives an automobile into a shop for repairs. In some cases, the customer may be a third party such as the spouse, child, other relative or friend of the owner of the automobile. An authorized customer, such as the owner or a third party who may authorize repairs, usually will be consulted before repairs may begin. In situations in which a third party brings the car in for repair, that third party may or may not be an authorized customer.

A repair specialist, typically an automotive mechanic in a repair shop, then evaluates the automobile in order to determine necessary or desirable repairs. The repair specialist then provides an estimator with a description of the proposed repair operation. The estimator then prepares an estimate of the cost of the proposed repair operation to the owner or other authorized customer. An estimator is an individual utilizing a system for obtaining job classifications and cost estimates for proposed repair operations to customers using the repair specialists' description of the proposed repair operation. The authorized customer then authorizes the proposed repair operation and the repair specialist completes the authorized repair operation. Some job estimate scenarios do not involve more than the individual repair specialist.

These scenarios provide no easy way for a customer unfamiliar with automotive operation or repair to obtain basic information about the scope or nature of the proposed repair operation. The repair specialist may educate the individual by describing the damaged part and the proposed repair operation. However, this is undesirable because the repair specialist's time is most valuably employed in ascertaining and completing authorized repairs. Furthermore, the repair specialist is not typically able to provide any instruction regarding the proposed repair operation to a customer in layman's terms. The customer may obtain outside advice from other specialists, family or friends. The customer may search the internet in order to obtain information relating to the proposed repairs. However, each of these options requires affirmative action on the part of the customer and may require the customer to already have some familiarity with or deep knowledge of with the parts being replaced or the processes being undertaken.

### DESCRIPTION OF THE DRAWINGS

FIG. 1 is a block diagram of an environment in which a job estimate may be developed.

FIG. 2 is a block diagram of a computing device.

FIG. 3 is a block diagram of a system for job estimate development.

FIG. 4 is a series of screen displays showing job estimate development and a database system.

FIG. 5 is a flowchart of a method of job estimate development.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

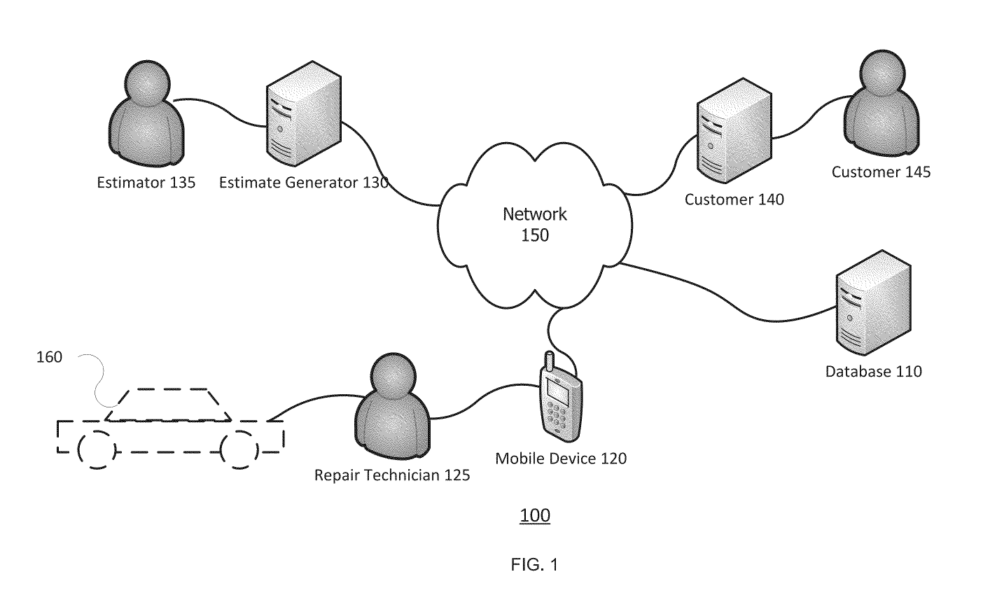

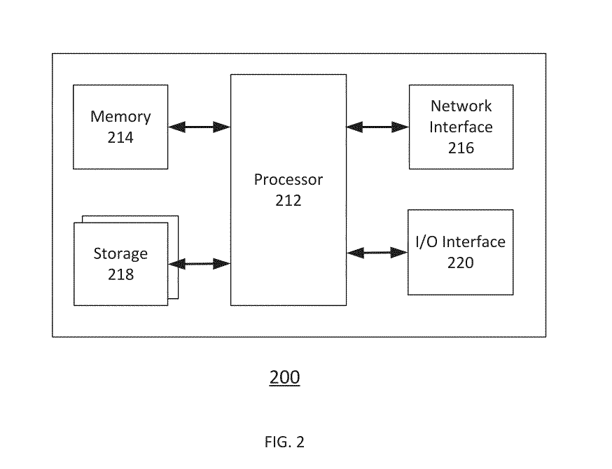

Referring now to FIG. 1, there is shown an environment 100 in which a job estimate may be developed. The environment 100 includes a database system 110, a mobile device 120, an estimator system 130, and a customer system 140. The environment 100 may be implemented using distributed computing and interconnected by the network 150. Each of the database system 110, mobile device 120, estimator system 130 and customer system 140 are computing devices described below with reference to FIG. 2.

Each of the mobile device 120, estimator system 130 and customer system 140 are used by individuals—a repair technician 125, an estimator 135 and a customer 145, respectively. The mobile device 120, estimator system 130 and customer system 140 may be personal computers, laptops, portable telephones, tablet computers or other similar computing devices. The mobile device 120 is used by the human repair technician 125 while inspecting an automobile 160 for necessary repairs. The mobile device 120 may be or include a digital camera. The estimator system 130 may be used by an estimator 135 to prepare estimates of costs associated with a proposed repair. The customer 145 may operate a customer system 140 to receive and authorize proposed repairs.

The network 150 may be or include a local area network, a wide area network, a personal area network, the Internet, an intranet, or any combination of these. The network 150 may be or include a mobile telephone network, radio network or wireless internet network suitable for connecting to the mobile device 120. The network 150 may have physical layers and transport layers according to IEEE 802.11, Ethernet or other wireless or wire-based communication standards and protocols such as WiMax®, Bluetooth®, the public switched telephone network, a proprietary communications network, infrared, and optical.

The database system 110 may be a server computer running server software and connected to the network 150. The database system 110 may also include software enabling it to act as a web server, a database server, an application server or all of these and may be made up of one or more physical servers in a single location or a distributed group of servers.

As will be discussed in more detail below, the database system 110 accepts service reports generated by the repair technician 125 using mobile device 120 and provides data pertaining to the estimated costs associated with the repairs proposed by those service reports. The database system 110 also stores and provides educational content.

A unit of “educational content” as used herein is a pre-created image, video or interactive program that describes some or all of a type of repair operation. Several units of educational content or more may be referred to collectively as “educational content.” Units of educational content may be stored in a database, such as the database system 110. The database may have more than one educational content unit per type of repair operation, and a given unit may be descriptive of multiple types of repair operations. The database may therefore associated a number of units with a given type of repair operation. Furthermore, the type of repair operation may include steps which themselves are a type of repair operation.

Units of educational content are geared toward an average automotive customer with little or no knowledge of the mechanics involved in a properly-functioning automobile. The units of educational content may be superimposed or otherwise supplemented with textual descriptions of a type of repair operation. The units of educational content may include reference numbers or other call-outs in order to direct a customer's attention. Units of educational content may provide to a customer, among other things, background information regarding a proposed repair operation, information regarding the purpose of the proposed repair operation and information regarding the consequences of failing to complete a proposed repair operation.

Interactive educational content may enable a customer to interact with elements of an interactive interface to bring up various aspects of the process of the repair operation. For example, a customer may be able to interact with an image of a muffler to hear, read and/or watch a description of the purpose of a muffler. A customer may be able to click on an image of a new muffler to hear, read and/or watch a description of the installation process. The educational content may include auditory and vibratory output, for example to show the difference between proper and improper operation of a muffler. In this way, the educational content may be interactive and customized based upon that customer's preferences.

A unit of educational content may pertain to a single “repair operation” or “job.” The individual steps taken in a repair operation are “repair steps.” For example, a repair operation may be removing and replacing a muffler. Another repair operation may be draining used motor oil, removing and replacing an oil filter followed by adding new motor oil. One unit of educational content may be associated with each of these example repair operations. The unit of educational content depicting a plurality of repair steps. The act of completing one step of the repair operation is completion of a “repair step.” Completion of all repair steps is a “completed repair operation.”

A repair operation may include installing a replacement or new part, making a repair, performing a service, completing an installation or performing labor in furtherance of any of the above. At least one unit of educational content may be associated with each repair operation in a database. A single unit of educational content, for example, one pertaining to replacement of a muffler, may be used for all muffler replacements. Alternatively, individual units of educational content may be associated with muffler replacement for each make, model, year, engine, transmission or various other options associated with a particular automobile. Using a database, appropriate units of educational content may be automatically identified by computer software or identified manually by an estimator.

A “proposed repair operation” is a repair operation that has not yet been performed, typically because a customer has yet to authorize it.

Returning to FIG. 1, the mobile device 120 includes wireless network capability suitable for connecting to the network 150, a still and/or video camera, and communications capability, including multimedia messaging or email software.

The repair technician 125, one or more humans, interacts with the mobile device 120 to capture one or more images of the automobile 160 using a camera in or associated with the mobile device 120. The images may be still images or video. The mobile device 120 may then be used to send a service report including those images to the database system 110, using general purpose software on the mobile device to send a multimedia message (a short message service text message incorporating photographic, audio and/or motion picture elements) or an email including the images. Alternatively, the repair technician 125 may use special purpose software on the mobile device 120 to create the service report and upload it directly to the estimation and educational server 110. Still further alternatively, the mobile device may be used to create images that are then uploaded and sent by a different device to the estimation and educational server 110.

The term “service report” refers to data including a textual description of the proposed repair operation and the images. In addition, the service report may include the location of the automobile, data pertaining to a computerized evaluation of the automobile, codes or database identifiers suitable for identifying parts or labor elements that make up all or a part of the proposed repair operation or any other objective measures of the automobile's current status. The service report may include a text portion describing the repair in sentences or may be written in shorthand using part, service, repair and/or automobile codes suitable to identify the exact parts, services, repairs and the automobile type on which the repairs are proposed.

The estimate generator system 130 is a computing device running software utilized by a human estimator 135 to access the database system 110 to obtain service reports created by repair technicians 125. In some cases, the estimator 135 may be the repair technician 125 and/or the mobile device 120 may incorporate the estimate generator system 130. Software on the estimate generator system 130 may use the network 150 to access the mobile device 120 to obtain service reports. The estimate generator system 130 also may be used to obtain cost data on the database system 110 in order to prepare a repair cost estimate. The service report and cost data, together, may be used by an estimate generator system 130 to prepare the repair cost estimate which is an estimate of the costs associated with the proposed repair operation identified in the service report.

The customer client system 140 is a computing device having a user interface for delivering the repair cost estimate and educational data to the customer 145 and accepting authorization for the proposed repair from the customer 145.

Turning now to FIG. 2 there is shown a block diagram of a computing device 200, which is representative of the server system, client systems, mobile devices and other computing devices discussed herein. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 212 coupled to a memory 214, storage 218, a network interface 216 and an I/O interface 220. The processor 212 may be or include one or more microprocessors, field programmable gate arrays (FPGAs), application specific integrated circuits (ASICs), programmable logic devices (PLDs) and programmable logic arrays (PLAs).

The memory 214 may be or include RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212.

The storage 218 provides non-volatile, bulk or long term storage of data or instructions in the computing device 200. The storage 218 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 218 and does not include transitory media such as signals or waveforms. In some cases, such as those involving solid state memory devices, the memory 214 and storage 218 may be a single device.

The network interface 216 includes an interface to a network such as network 150 (FIG. 1).

The I/O interface 220 interfaces the processor 212 to peripherals (not shown) such as displays, keyboards and USB devices.

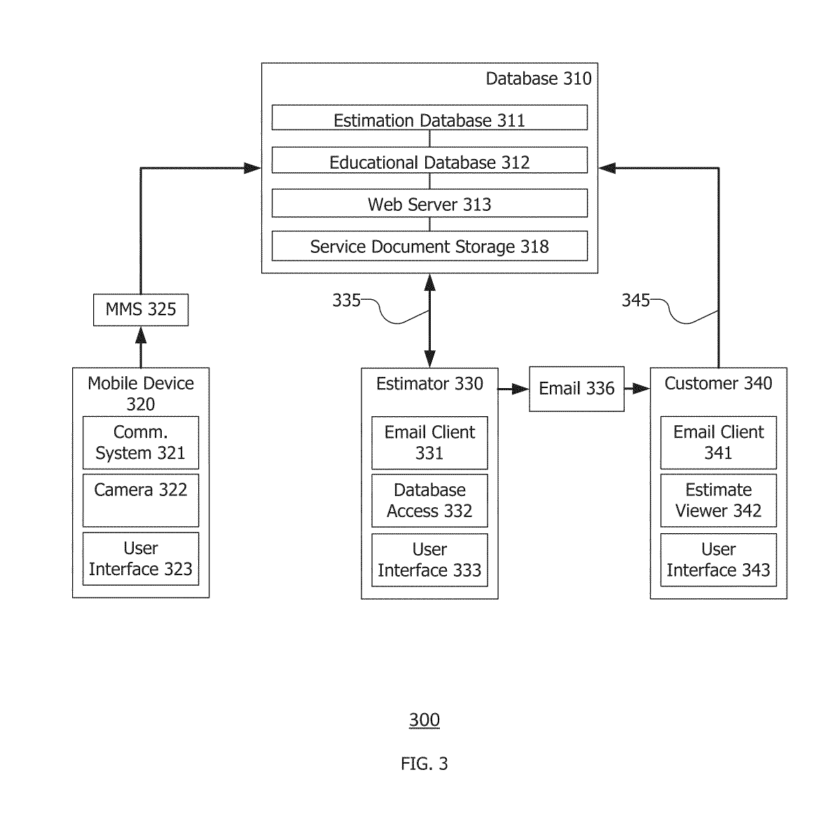

FIG. 3 is a block diagram of a system 300 for job estimate development. The system 300 includes a database system 310, a mobile device 320, an estimator system 330 and a customer system 340 such as those described with reference to FIG. 1.

The database system 310 includes an estimation database 311, an educational database 312, a web server 313 and service document storage 318. The estimation database 311 stores data pertaining to parts and labor costs. The educational database 312 stores educational content. The web server 313 serves web requests, such as requests to view service reports and educational data. The service document storage 318 stores service reports from repair technicians and history data pertaining to past repairs completed for a particular customer or automobile.

The mobile device 320 is a computing device including a communication system 321, a camera 322 and a user interface 323, each made up of hardware and software elements. The camera 322 may be used to capture images and the user interface is suitable for receiving interaction from a repair technician. The mobile device 320 communicates with the estimation and database system 310 via MMS 325.

The estimator system 330 is a computing device including software for an email client 331, and database access 332. The email client 331 is software for sending, receiving and viewing emails. The database access 332 is software for accessing databases, such as the estimation database 311 and educational database 312. The estimator system 330 includes a user interface 333 suitable for receiving interaction from an estimator, the user interface 333 made up of software and hardware elements. The estimator system 330 communicates with the database system 310 via network communications 335. The estimator system 330 communicates with the customer system 340 via email 336.

The customer system 340 is a computing device including an email client 341 and an estimate viewer 342, both implemented as software. The email client 341 is software for sending, receiving and viewing emails. The estimate viewer 342 may be or include web browser software or other software sufficient to access educational data stored in the educational database 312 and served by the web server 313. The customer system 340 includes a user interface 343 for receiving interaction from a customer, the user interface 343 made up of both software and hardware. The customer system 340 communicates with the database system 310 via network communications 345.

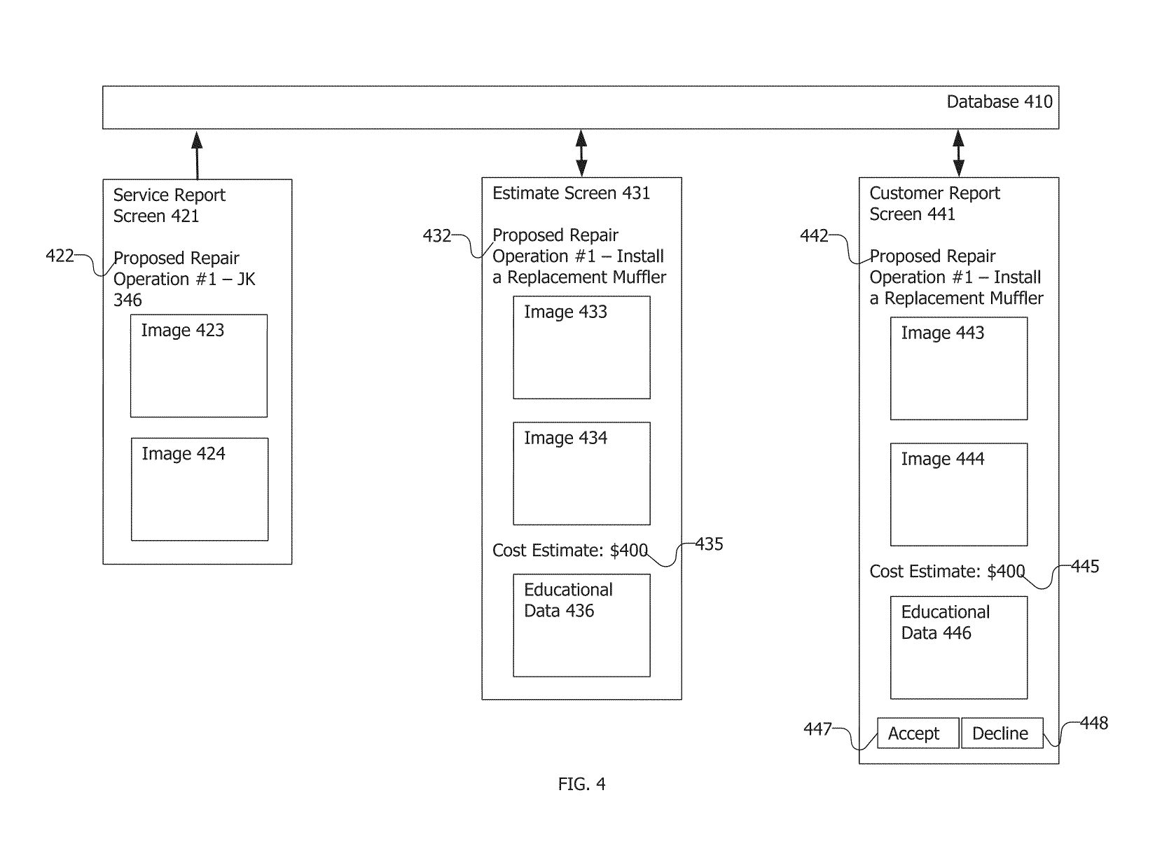

Turning now to FIG. 4 a series of screen displays showing job estimate development and a database system 410 are shown. The service report screen 421 shows a display screen of the service report that may be provided by a repair technician to the database system 410. The service report screen 401 includes an identification of a proposed repair operation 422. The proposed repair operation 422 is intended to address an issue discovered by the repair technician. The description shown in service report screen 421 is “JK 346” which is a job code that may identify a part number or a particular type of repair operation.

A “job code” is a, typically, alphanumeric code used by the database 410 to uniquely identify a particular repair operation. The repair technician may enter the code at the service report generation stage or may describe the proposed repair operation. If it is not identified by a job code in the service report, the description provided by the repair technician may be converted one or more job codes by the estimator as the repair cost estimate is prepared. The process of selecting job codes, either by the repair technician or estimator may be assisted by a computer, such as the mobile device 120 or estimate generator 130, with access to the database 410.

Along with the description of the proposed repair operation 422 in the service report screen 421, two images are provided, image 423 and image 424. This service report screen 421 is representative of the data that is provided to the database system 410 for use by the estimator in preparing the repair cost estimate.

The estimate screen 431 shows an example of a display of a repair cost estimate as created by an estimator. The proposed repair operation 432 has been converted from the job code “JK 346” to “Install a Replacement Muffler” by the estimator. In other words, the special language of the repair technician may be translated into the ordinary language of the customer. This process may be automatic or require estimator action to select one or more proposed repair operations. The same images 433 and 434 are provided to the estimator as he or she prepares the repair cost estimate. In addition, a cost estimate 435 is generated by the estimator. This process may be fully or partially automated for the estimator using the job codes and the database 410 to obtain cost estimate data.

While preparing an estimate, the estimator may have access to data in the database 410 pertaining to a proposed repair operation, the customer and the customer's vehicle in the database 410. This information may be stored, for example, based upon a customer number, a vehicle identification number (VIN) or license plate number. This data may include customer input such as the reason for bringing the automobile in for repair, job codes associated with the current and past repair operations, images from current and past service reports, customer requests for particular services, educational data describing the proposed repair operation, educational data describing why a particular repair operation is necessary, the costs associated with such a repair operation in addition to the results or potential results of failing to complete the repair operation, any environmental impacts, future costs and any safety implications for failing to complete the repair operation.

The customer report screen 441 shows an example of a display of a repair cost estimate to a customer. The customer report screen 441 includes the descriptive name for the proposed repair operation 442 that was provided by the estimator. The description of the proposed repair operation 442 may be subdivided into parts and labor elements or may be presented as a single operation to a customer In addition, once the estimator has created a repair cost estimate, education data 436 is associated with the proposed repair 432. This association may take place automatically, using the job codes and information about the customer and the customer's automobile to access the database 410 in order to identify and obtain relevant educational data 436. The customer report screen 441 may also include images 443 and 444, corresponding to images 413 and 414 provided by the repair technician to the database system 410. In addition, a cost estimate 445 for the proposed repair operation 442 of “$400” in this case is also provided. Along with the repair cost estimate, the educational data 446 identified at the estimation stage is also provided. The customer may accept or decline the proposed repair 442 via the accept button 447 and decline button 448.

The customer report screen 441 may include additional proposed repairs, images, cost estimates and educational data for each proposed repair operation. The customer report screen 441 also enables a customer to accept or decline each repair individually and may enable the customer to accept or decline all repairs at the same time. The estimate screen 441 may also be dynamic such that more complex educational content may be displayed to a customer that is more familiar with automobile operation than one who is totally unfamiliar.

Description of Process

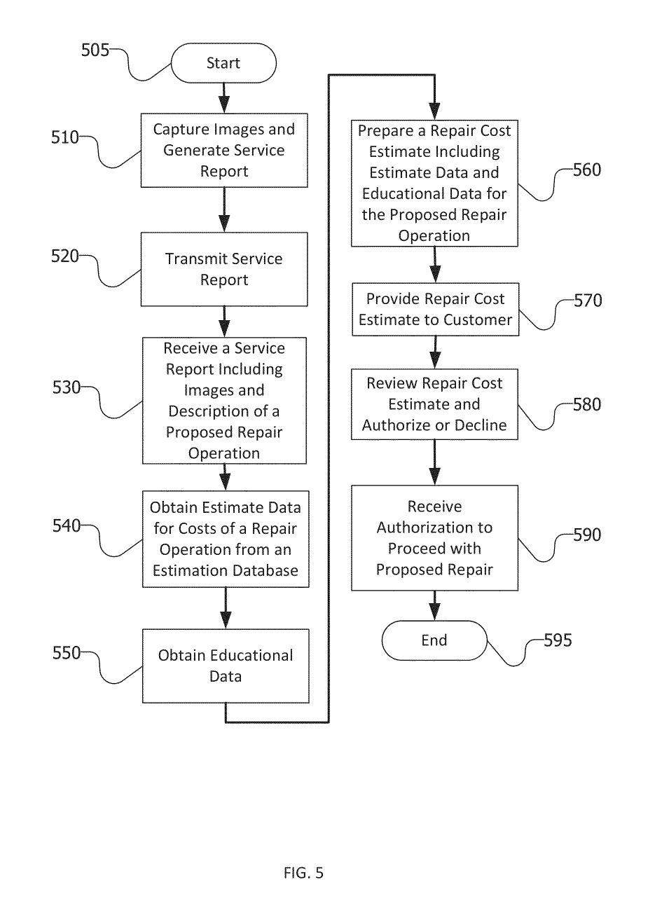

Turning now to FIG. 5, a flowchart of a method of job estimate development is shown. A repair technician uses a mobile device, such as mobile device 320 (FIG. 3) to capture one or more images of a subject automobile and to prepare a service report. In particular, the images depict the part to be replaced or the area or part needing repair. The repair technician then transmits the service report including the images to a database system, such as the database system 310 (FIG. 3), via a network 520.

The database system receives the service report 530. This service report may be provided to the database system via multimedia message. The service report may be provided by email or by a direct data upload or may be transmitted or broadcast in other ways. Once delivered, the service report may be stored in data storage such as the service document storage 318 (FIG. 3).

An estimator may then access the service report stored in an estimation database of the database system using database access software. The service report is used to obtain cost data from the estimation database for the repair operation and any replacement parts identified by the service report.

This aspect of the process may be automated such that any keywords, shorthand or part, service, repair and/or automobile codes may be parsed by an estimator client system in order to obtain repair data uniquely identifying part numbers and the labor associated with a particular repair operation. This repair data may be used to obtain an estimate of the cost of a particular repair operation using an estimation database.

For example, a replacement muffler for a particular make, model and year of automobile may be identified by a part number in an estimation database, such as estimation database 311 (FIG. 3), and include an associated cost. Similarly, the labor associated with replacing a muffler on a particular car may have an associated time estimate to complete the replacement. The estimation database may then be accessed, manually or automatically in order to obtain estimate data, including the costs associated with the repair operation 540 using the repair data.

Once the precise nature of the repair operation has been identified by the repair data, database access software may also be used to access an educational database, such as educational database 312 (FIG. 3), in order to obtain educational data 550 pertaining to that repair data. The repair data may be used to identify the precise type of proposed repair. Returning to the example above, the part number of the muffler can be used to identify the manufacturer, make and year range of the automobile associated with the proposed repair. Similarly, the labor estimate for a “muffler replacement” can be used to identify the proposed repair operation.

Educational data for each repair operation associated with the repair data may be obtained from the educational database. A plurality of parts and/or labor items may be used to identify to the appropriate educational data units for the repair operations.

Returning to the example above, an estimator system, such as estimator system 330 (FIG. 3), may obtain a unit of educational content including a video description of a muffler replacement. The unit of educational content may describe the muffler, the muffler's location, the muffler's function and the level of its importance to the operation of an automobile. The unit of educational content may further describe the process undertaken to remove and replace a muffler with a new muffler. For example, a video may depict a welding torch cutting away a faulty muffler, a repair technician replacing it with a new muffler, affixing a new muffler to the appropriate mounting brackets and welding the new muffler to the exhaust system of the automobile.

The estimator may then prepare a repair cost estimate including the estimate data and the units of educational data associated with the proposed repair operation 560. This preparation may include formatting the estimate data and the educational data for the customer. For example, the customer may have indicated a desire to receive links to educational data instead of embedded educational data units. If so, the preparation will include inserting links into the repair cost estimate in place of any educational data units that may, by default, be embedded directly into an email.

The customer may also have indicated a desire to receive a text message directing the customer to a secure web page including the repair cost estimate rather than receiving an email including the repair cost estimate. Similarly, the preparation may include identifying the customer with authorization to approve a repair in order to provide the repair cost estimate to that customer rather than another individual without authority to approve the proposed repair operation.

The repair cost estimate may then be provided as directed to the customer 570. For example, the repair cost estimate may be provided via the email client 341 of the customer system 340 (FIG. 3). The repair cost estimate is provided to the customer so that the customer can make an informed decision regarding the proposed repairs.

The customer may then review the repair cost estimate and authorize or decline the proposed repair operations 580. Software such as the estimate viewer 342 (FIG. 3) may be used.

Once the customer has received and reviewed the repair cost estimate, the user may authorize or decline of some or all of the proposed repairs 560. The acceptance or declination may be stored, for example in the service document storage 311 (FIG. 3) as a part of a service history of the automobile. Once authorization of the proposed repair is received, the repair technician may receive a notification to begin the accepted repairs.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A method of job estimate development comprising:
receiving a custom image of a specific automobile, the image including a depiction of a subject of a proposed repair operation;
obtaining an estimate for a proposed repair operation on the specific automobile, wherein the proposed repair corresponds to the image, the estimate including parts costs and labor costs associated with the proposed repair operation;
obtaining a unit of educational content associated with the proposed repair operation, the unit of educational content pre-associated with the proposed repair operation and selected from a library of educational content, the unit of educational content including a visual depiction of the proposed repair operation; and
providing a repair cost estimate including the estimate data, the image and the unit of educational content to a customer for review prior to authorization of the proposed repair.

2. The method of claim 1 wherein the unit of educational content includes a narrated video of the proposed repair operation.

3. The method of claim 1 further comprising outputting the repair cost estimate as an electronic document suitable for email transmission to the customer.

4. The method of claim 1 further comprising receiving repair data including a description of the proposed repair operation along with the image.

5. The method of claim 4 wherein the estimate data is obtained automatically based upon the repair data.

6. The method of claim 1 wherein authorization is received from the customer via one of email and short message service text message.

7. Apparatus comprising a machine readable storage medium storing a program having instructions which when executed by a processor will cause the processor to:
receive a custom image of a specific automobile, the image including a depiction of a subject of a proposed repair operation;
obtain estimate data for a proposed repair operation on the specific automobile, wherein the proposed repair corresponds to the image, the estimate data including part costs and labor costs associated with the proposed repair operation;
obtain a unit of educational content associated with the proposed repair operation, the unit of educational content per-associated with the proposed repair operation and selected from a library of educational content, the unit of educational content including a visual depiction of the proposed repair operation; and
provide a repair cost estimate including the estimate data, the image and the unit of educational content to a customer for review prior to authorization of the proposed repair.

8. The apparatus of claim 7 wherein the unit of educational content includes a narrated video of the proposed repair operation.

9. The apparatus of claim 7 wherein the instructions will further cause the processor to output the repair cost estimate as an electronic document suitable for email transmission to the customer.

10. The apparatus of claim 7 wherein the instructions will further cause the processor to receive repair data including a description of the proposed repair operation along with the image.

11. The apparatus of claim 10 wherein the estimate data is obtained automatically based upon the repair data.

12. The apparatus of claim 7 wherein authorization is received from the customer via one of email and short message service text message.

13. The apparatus of claim 7 further comprising:
a network interface;
a processor;
a memory; and
wherein the processor and memory comprise circuits and software for performing the instructions on the storage medium.

14. A method of job estimate development comprising:
capturing an image of a specific automobile, the image including a depiction of a subject of a proposed repair operation;
transmitting the image and repair data including a description of the proposed repair operation to a data storage via a network;
obtaining estimate data for a proposed repair operation on the specific automobile using the repair data, the estimate data including part costs and labor costs associated with the proposed repair operation, wherein the proposed repair corresponds to the image;
obtaining a unit of educational content associated with the proposed repair operation using the repair data, the unit of educational content pre-associated with the proposed repair operation and selected from a library of educational content, the unit of educational content including a visual depiction of the proposed repair operation;
providing a repair cost estimate including the estimate data, the image, the description and the unit of educational content to a customer for review prior to authorization of the proposed repair operation.
